(19) United States
(12) Patent Application Publication
(10) Pub. No.: US 2012/0204696 A1
(43) Pub. Date: Aug. 16, 2012

(54) CUTTING MACHINE, PARTICULARLY FOR HIDES AND THE LIKE, WITH SIMPLIFIED ACCESSIBILITY

(75) Inventor: Stefano Zorzolo, Vigevano (IT)

(73) Assignee: COMELZ S.P.A., Vigevano (IT)

(21) Appl. No.: 13/501,170

(22) PCT Filed: Sep. 27, 2010
(86) PCT No.: PCT/EP2010/064285

§ 371 Date: Apr. 10, 2012

(30) Foreign Application Priority Data
Oct. 13, 2009 (IT) MI2009A001747

(51) Int. Cl. B26D 7/20; C14B 5/00

(52) U.S. Cl. 83/437.1; 83/859

(57) ABSTRACT

A cutting machine, particularly for hides and the like, comprising a supporting structure that is adapted to support a worktable, the worktable being surmounted at least partially by an arm which supports at least one cutting head that is movable along the arm, the arm being moved along one side of the worktable, the worktable being free from obstacles along the sides that are adjacent to the side along which the arm is moved, the worktable comprising a supporting element that is adapted to allow the positioning of portions of the hide for cutting and the repositioning on the cutting area of a subsequent portion of the hide for a subsequent cutting operation, by means of moving the supporting element.

### TECHNICAL FIELD

The present invention refers to a cutting machine for hides and the like, with simplified accessibility. More specifically, the invention refers to a cutting machine with worktable with simplified accessibility.

### BACKGROUND ART

Nowadays in cutting machines, the use of a conveyor belt is known in order to feed material in rolls or sheets onto the cutting table or worktable of the machine, and to transfer the cut material onto a cascading unloading area on the conveyor belt, so as to perform the cutting operation and the operation to remove the cut material in parallel, in the case where the positioning is already programmed and is done automatically.

Moreover, the conveyor belt enables the transfer of material from a positioning area to a cutting area and then onto an unloading area, all arranged in a cascade, so as to perform positioning, cutting and unloading operations in parallel, for example on machines where the positioning is performed on the machine by the operator.

The use is also known of cutting machines, particularly for hides and the like, with simplified access, i.e. with a worktable that is free along the front side which faces the operator and along the two adjacent, longitudinal sides. The width of the worktable is limited to the width of the side that faces the operator, and therefore the positioning of the material to be cut must compulsorily be limited to that space.

Moreover, the operations to unload material cannot be performed in parallel on the same cutting area, because this area is the same area that is used by the cutting operations.

2. Disclosure of the Invention

The aim of the present invention is to provide a cutting machine, particularly for hides and the like, that combines the advantages of a machine with a conveyor belt with a machine with simplified accessibility to the worktable.

Within this aim, an object of the present invention is to provide a cutting machine, particularly for hides and the like, that enables cutting operations to be carried out on templates placed on an area that is separate from the area on which the hides were positioned.

Another object of the present invention is to provide a cutting machine, particularly for hides and the like, that enables cut pieces to be collected, once the cutting operation has been carried out, on an area that is separate from the area on which the cutting operations were carried out.

Another object of the present invention is to provide a cutting machine, particularly for hides and the like, that makes it possible, after cutting and removing the cut pieces, to reposition the material on the cutting area, without removing it from the support on which it rests, by means of a system for moving such support.

Another object of the present invention is to provide a cutting machine, particularly for hides and the like, that is highly reliable, easy to implement and has a low cost.

This aim, as well as these and other objects which will become better evident hereinafter, are achieved by a cutting machine, particularly for hides and the like, comprising a supporting structure adapted to support a worktable, said worktable being surmounted at least partially by an arm which supports at least one cutting head that is movable along said arm, said arm being moved along one side of said worktable, said worktable being free from obstacles along the sides that are adjacent to said side along which said arm is moved, characterized in that said worktable comprises a supporting element that is adapted to allow the positioning of portions of said hide for cutting and the repositioning on said cutting area of a subsequent portion of said hide for a subsequent cutting operation by means of the movement of said supporting element.

### BRIEF DESCRIPTION OF THE DRAWINGS

Further characteristics and advantages of the present invention will become better apparent from the description of a preferred, but not exclusive, embodiment of a cutting machine according to the present invention, illustrated by way of a non-limiting example in the accompanying drawings, wherein:

FIG. 1 is a perspective view of the cutting machine according to the present invention;

FIG. 2 is a perspective view of a second embodiment of the cutting machine according to the present invention.

### WAYS OF CARRYING OUT THE INVENTION

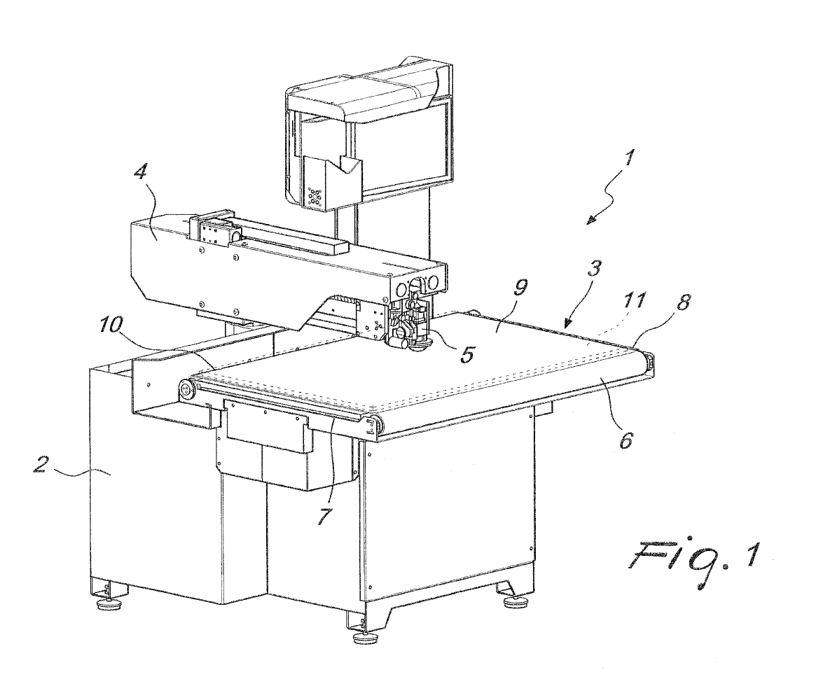

With reference to FIG. 1, the cutting machine according to the present invention, which is generally indicated by the reference numeral 1, comprises a supporting structure 2 adapted to support a worktable or cutting area 3, the supporting structure 2 being surmounted at least partially by an arm 4 that is adapted to move at least one cutting head 5. Conveniently, the worktable or cutting area 3, at its front side 6, i.e. the side that faces the operator, as well as the two transversal sides 7 and 8 which are adjacent to the front side 6, have total accessibility.

The cutting head is movable along the arm 4.

The fourth side of the worktable or cutting area, indicated by the reference numeral 10, is the side where the supporting structure for the arm 4 adapted to move the cutting head 5 is provided.

Therefore, the side 10 is not free from obstacles, unlike the other three sides of the worktable or cutting area 3.

Substantially, therefore, the worktable 3 does not have obstacles at the sides 6, 7 and 8, i.e. along such sides. Conveniently, the worktable or cutting area 3 can be constituted by a supporting element 11, for example constituted by a mat. In FIG. 1 the supporting element 11 is drawn above a conveyor belt. The supporting element 11 is an alternative to the conveyor belt, although FIG. 1 illustrates it on top of the conveyor belt.

The supporting element 11 is manually movable in such a way as to move it both longitudinally and in parallel with the front edge 6 of the worktable or cutting area 3, and transversally with respect to such edge 6, in such a way as to position it to the operator's will.

The supporting element 11, which protrudes laterally from the supporting structure 2 of the cutting machine, ensures an extension of the worktable or cutting area 3, to the benefit both of positioning and of cutting the hides.

Conveniently, the supporting element can be constituted by a conveyor belt 9 that is movable both longitudinally, i.e. in parallel with the sides 7 and 8 of the worktable 3, and transversally, i.e. in parallel with the front side 6 and the corresponding rear side 10 of the worktable 3. In this case, obviously, the supporting element is not movable manually.

In this case the conveyor belt 9 constitutes the worktable 3.

The provision of a conveyor belt, moved longitudinally or transversally or in both directions, enables an extension of the depth of the worktable 3 towards the operator, i.e. towards the free side 6 of the worktable 3, thus creating a space that is sufficient to be able to perform the positioning on a front portion of the worktable 3 that is free (or that has been freed) from the cutting head 5, so operating in parallel with the cutting operations performed in a cascade from the conveyor belt.

The transversal movement of the conveyor belt is constituted by a translational movement of the belt.

Unlike known art, the operations to unload cut pieces are performed on the cutting area proper, as the cutting head progressively frees up access to the cut pieces. To facilitate collection of the cut pieces, it is also possible to make the conveyor belt move backwards, i.e. towards the operator, so bringing the pieces that have been cut towards such operator.

Similarly, it is also possible to use the conveyor belt in another work cycle where the belt moves backwards, towards the operator, in which the positioning is performed on the cutting area while the collection of cut pieces is performed on the front portion of the worktable 3, which is free from cutting.

In practice it has been found that the cutting machine according to the invention fully achieves the aim and objects, since it enables, by way of the provision of the conveyor belt to a conventional machine with free access on three sides of the cutting area, the extension of the aforementioned cutting area, by creating a space for positioning the material to be cut in front of the cutting area, thus enabling a cutting operation to be performed in parallel with an operation to position the material by the operator.

Moreover, the unloading operations can be performed both in the cutting area proper, as the cutting elements progressively free up access to the cut material, and by bringing the cut pieces, by way of the backward advancement of the conveyor belt, towards the operator.

If the supporting element is not the conveyor belt but a static supporting element, there is still the advantage of having an extension of the worktable and the ability to manually move the supporting element so as to bring the cut pieces closer, or move them farther away, and there is also the advantage of allowing the positioning of material in an area that is free from the cutting elements.

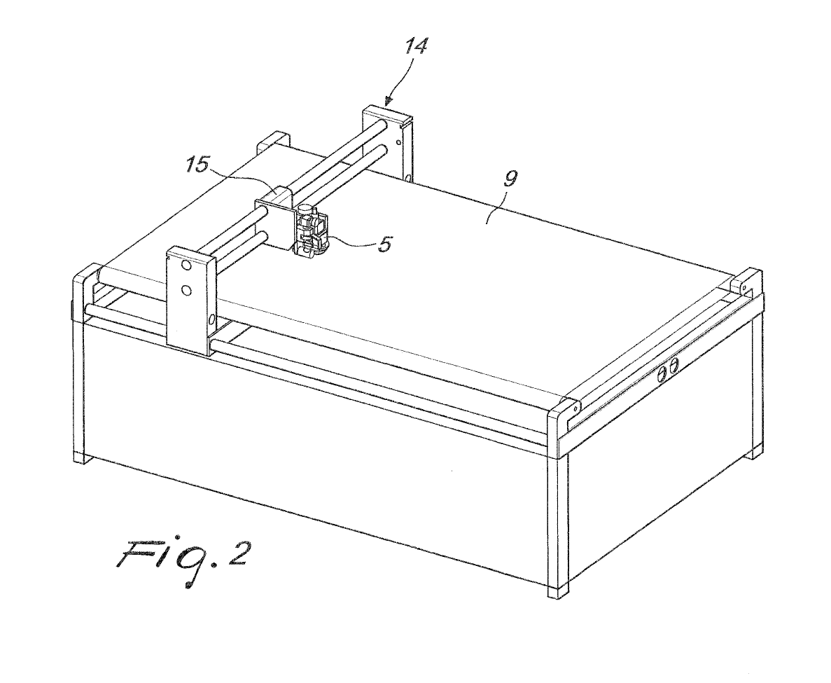

FIG. 2 shows a second embodiment of the cutting machine according to the invention, in which, differently from the first embodiment, the arm is constituted by a movable bridge 14 which is arranged transversally and above the supporting element 9 and which is movable along the supporting element, transversally with respect to the direction of movement of the supporting element.

The term “transversally” when used with the movable bridge means that the movable bridge 14 moves in the direction that is transversal with respect to the “longitudinal” direction of movement of the supporting element 9.

The movable bridge substantially overhangs the entire supporting element 9, the bridge being supported to the side of the supporting element.

The movable bridge 14 is provided with a cutting head 15 that is in turn movable transversally with respect to the direction of movement of the movable bridge 14.

The supporting element 9 in this case is a conveyor belt that is movable transversally with respect to the direction of movement of the movable bridge 14, in parallel with the direction of movement of the cutting head 15.

The machine, thus conceived, is susceptible of numerous modifications and variations, all of which are within the scope of the appended claims.

Thus, for example, the conveyor belt 9 can rotate continuously along the longitudinal direction of the worktable and perform a translational motion along the transversal direction of such table.

Moreover, all the details may be substituted by other, technically equivalent elements.

In practice the materials employed, as well as the dimensions and the contingent shapes, may be any according to requirements and to the state of the art.

The disclosures in Italian Patent Application No. MI2009A001747 from which this application claims priority are incorporated herein by reference.

1-10. (canceled)

11. A cutting machine, particularly for hides, comprising a supporting structure adapted to support a worktable, said worktable being surmounted at least partially by an arm which supports at least one cutting head that is movable along said arm, said arm being moved along one side of said worktable, said worktable being free from obstacles along the sides that are adjacent to said side that lies opposite the side along which said arm is moved, wherein said worktable comprises a supporting element that is adapted to allow the positioning of portions of said hide for cutting and the repositioning on said cutting area of a subsequent portion of said hide for a subsequent cutting operation by means of the movement of said supporting element.

12. The cutting machine according to claim 11, wherein said supporting element is adapted to be moved manually by the operator both in a longitudinal direction of the worktable and in a transversal direction of the worktable.

13. The cutting machine according to claim 12, wherein said supporting element is a mat.

14. The cutting machine according to claim 11, wherein said supporting element is a conveyor belt.

15. The cutting machine according to claim 14, wherein the conveyor belt is at least movable along a longitudinal direction of the worktable.

16. The cutting machine according to claim 15, wherein said conveyor belt is adapted to perform a translational motion along a transversal direction of the worktable.

17. The cutting machine according to claim 14, wherein said conveyor belt can be moved, in a longitudinal direction of said worktable, both toward a front side of the worktable and toward a rear side of the worktable.

18. The cutting machine according to claim 11, wherein said arm is supported in a cantilever manner at the side along which it is moved.

19. The cutting machine according to claim 11, wherein said arm is constituted by a movable bridge located above said supporting element, and said supporting element is a conveyor belt that is movable along the longitudinal direction of the worktable, in parallel with the direction of movement of said cutting head along said bridge.

20. The cutting machine according to claim 11, wherein said worktable is free from obstacles along the side that lies opposite said one side along which the cutting head is moved.
